(19) United States
(12) Patent Application Publication
(10) Pub. No.: US 2026/0070515 A1
(43) Pub. Date: Mar. 12, 2026

(54) SYSTEM FOR CLEANING AN OPTICAL SURFACE

(71) Applicant: VALEO SYSTEMES D'ESSUYAGE, La Verriere (FR)

(72) Inventors: Frederic GIRAUD, La Verriere (FR); Jean Michel JARASSON, La Verriere (FR); Frederic BRETAGNOL, La Verriere (FR); Gerald CAILLOT, La Verriere (FR)

(73) Assignee: VALEO SYSTEMES D'ESSUYAGE, La Verriere (FR)

(21) Appl. No.: 19/106,696

(22) PCT Filed: Aug. 25, 2023
(86) PCT No.: PCT/EP2023/073419

§ 371 Date: Feb. 26, 2025

(30) Foreign Application Priority Data
Aug. 31, 2022 (FR) 2208718

(51) Int. Cl. B60S 1/08; B60S 1/54; B60S 1/56

(52) U.S. Cl. CPC B60S 1/0848; B60S 1/546; B60S 1/566

(57) ABSTRACT

The invention relates to a system for cleaning an optical surface of an optical device. The cleaning system includes a wiper blade for a window, the wiper blade being arranged to wipe a wiping zone of the window that is separate from an optical surface. The blade bearing a nozzle for spraying fluid, in particular air, in the direction of the optical surface. The cleaning system also includes an apparatus for setting fluid in motion, in particular a compressor or a blower, intended to supply the spray nozzle.

### TECHNICAL FIELD

The present invention relates to a system for cleaning an optical surface of an optical device, which optical device is joined to a vehicle window, in particular a windshield

### BACKGROUND OF THE INVENTION

The vehicle may be a land vehicle, marine vehicle or air vehicle.

In certain vehicles, a camera, for example of infrared type, is provided, mounted in an orifice of the windshield and outside the sweeping region of the one or more wiper blades. In this case, it is recommended to have specific washing systems for the camera since drops frequently remain on the camera after cleaning. Drops are also present when it rains.

### SUMMARY OF THE INVENTION

The invention aims in particular to remove any drops on the camera or pollution such as for example dust, snow, leaf debris, organic waste deposited on the optical surface of the camera, which is outside the sweeping region.

One subject of the invention is thus a system for cleaning an optical surface of an optical device, this cleaning system comprising:
a wiper blade for a window, this blade being arranged to wipe a wiping zone of the window that is separate from the optical surface, this blade bearing a nozzle for spraying fluid, in particular air, in the direction of the optical surface,
in particular an apparatus for setting fluid in motion, in particular a compressor or a blower, intended to supply the spray nozzle.

The invention makes it possible to clean, by virtue of the jet of fluid, in particular a jet of air, the optical surface of the optical device so as to ensure that this optical surface is sufficiently clean to allow the correct operation thereof. For example, the air sprayed by the nozzle according to the invention makes it possible to drive off any drops of water that are present on this optical surface. These drops could disrupt the detection of electromagnetic waves, such as infrared or visible waves, by the optical device. The optical surface is in particular the surface through which the waves enter the optical device, this surface for example facing a lens of the optical device.

This optical device forms an infrared sensor, for example. This optical device could also be arranged as an emitter of electromagnetic waves, for example an infrared emitter.

The invention furthermore makes it possible to benefit from the wiper blade in order to add this additional function of cleaning the optical surface of the optical device. The presence of the spray nozzle on the blade makes it possible to bring the fluid, in particular the air, as close as possible to the optical surface to be cleaned.

The cleaning allowed by the invention is of the type without contact between the blade and the optical surface to be cleaned. This is particularly advantageous when the optical device is joined to the window, projecting from this window. The invention makes it possible to clean without having to bring the blade into contact with the optical surface projecting from the window, and this avoids the risk of damaging the optical device, for example by the blade rubbing too hard on the optical surface. Thus, the cleaning is carried out by virtue of the jet of fluid and not by contact of the blade on the optical surface.

According to one of the aspects of the invention, the optical device is joined to a vehicle window, in particular a windshield. In particular, the optical device projects from the windshield.

According to one of the aspects of the invention, the fluid is air alone, or a liquid alone, or a mixture of liquid and air. This mixture of liquid and air may form a foam sprayed onto the optical surface to be cleaned.

According to one of the aspects of the invention, the spray nozzle is disposed at one end of the wiper blade, in particular an end of the blade, from among its two opposite ends, which passes closest to the optical surface during the sweeping.

According to one of the aspects of the invention, the spray nozzle comprises a fluid outlet orifice, in particular with a convergent shape in order to accelerate the fluid.

According to one of the aspects of the invention, the fluid outlet orifice is configured so as to orient the sprayed fluid outside of the wiping zone.

In other words, the fluid that is sprayed by this spray nozzle does not serve to clean the wiping zone.

According to one of the aspects of the invention, the outlet of the nozzle has a fluid outlet axis that is tangent to the axis of the wiper blade.

As a variant, the outlet of the nozzle has a fluid outlet axis that forms a non-zero angle with the longitudinal axis of the wiper blade, for example an angle of less than 20°, or even less than 5°.

According to one of the aspects of the invention, the spray nozzle comprises an internal fluid channel that opens onto the fluid outlet.

According to one of the aspects of the invention, this internal fluid channel has a fluid inlet configured to allow the connection of a pipe for conveying fluid toward the nozzle.

According to one of the aspects of the invention, the spray nozzle is formed by a part that is separate from the blade and is joined to the blade, in particular by snap-fastening, screwing or welding.

According to one of the aspects of the invention, the spray nozzle may be fastened to the blade in a removable manner.

As a variant, the nozzle forms part of the blade, being in particular formed on an endpiece of the blade. This endpiece is usually referred to as an “endclip”. This endpiece may have an aerodynamic profile, and be fastened to a mount that bears the squeegee of the blade.

According to one of the aspects of the invention, the spray nozzle may be fastened to the blade permanently, namely in a non-removable manner.

According to one of the aspects of the invention, the spray nozzle is disposed in the longitudinal extension of the wiper blade.

According to one of the aspects of the invention, the cleaning system comprises at least one pipe connecting a compressor to the spray nozzle.

According to one of the aspects of the invention, the wiper blade is arranged to be attached to a blade arm, and at least one pipe that connects the compressor to the spray nozzle runs along the blade arm, at least over a certain length.

According to one of the aspects of the invention, the blade arm is connected to an electric motor arranged to set it in wiping motion.

According to one of the aspects of the invention, the electric motor is coupled to an angular position sensor arranged to determine the angle that the blade arm makes with respect to a reference position.

According to one of the aspects of the invention, the compressor, which is in particular of the electric type, is arranged to compress fluid, for example air, which is then conveyed toward the spray nozzle.

According to one of the aspects of the invention, the compressor is placed on a fixed support separate from the wiper blade.

According to one of the aspects of the invention, the cleaning system comprises a compressed air reservoir supplied with compressed air from the compressor, and the spray nozzle is supplied with compressed air coming from this compressed air reservoir.

By virtue of this reservoir, which serves as a buffer reservoir, the invention makes it possible to have compressed air immediately available, which may be conveyed very rapidly toward the spray nozzle.

According to one of the aspects of the invention, the cleaning system comprises a valve, in particular a solenoid valve, arranged to, in the open position, let compressed air circulate from the reservoir toward the spray nozzle, and, in the closed position, stop the circulation of compressed air from the reservoir toward the spray nozzle.

According to one of the aspects of the invention, this valve may be controlled with a very rapid reaction time, making it possible to deliver compressed air to the spray nozzle in a very short time.

According to one of the aspects of the invention, the spray nozzle is connected to a reservoir of additional liquid, in particular a windshield washer liquid, so as to be able to be supplied, selectively, with this liquid alone, or with a mixture of this liquid and air, or with air alone.

According to one of the aspects of the invention, the cleaning system comprises a pump arranged to deliver liquid from the liquid reservoir toward the spray nozzle.

According to one of the aspects of the invention, a liquid path coming from the liquid reservoir and an air path coming from the air reservoir meet within a common pipe, upstream of the spray nozzle such that this spray nozzle can be supplied selectively with air and/or liquid.

According to one of the aspects of the invention, a non-return valve is placed on the air path in order to prevent liquid from being discharged into the air reservoir.

According to one of the aspects of the invention, a non-return valve is placed on the liquid path in order to prevent air from being discharged into the liquid reservoir.

According to another of the aspects of the invention, the spray nozzle is placed at a distance from the ends of the blade, for example at a location on the blade that is more than 5% or more than 10% of the total length of the blade away from the ends thereof.

According to one of the aspects of the invention, the nozzle is made of plastic.

According to one of the aspects of the invention, the optical device is a camera, in particular an infrared camera, arranged to detect the presence of drops of water on the window, so as to trigger the operation of the wiper blade in the event that drops of water are detected.

According to one of the aspects of the invention, the apparatus for setting the air in motion may be a blower, instead of the compressor. This blower is in particular a blower with radial blades.

According to one of the aspects of the invention, the optical device projects from the window such that the optical surface to be cleaned extends beyond the window.

Thus, the cleaning of this optical surface by a jet of air does not damage the optical device, unlike, for example, the passage of a blade over the optical device, which passage is liable to damage the optical device by abrasion since the latter extends beyond the window. The generation of undesirable noise by the passage of the blade over the optical device that extends beyond the window, or the premature wear and the deposition of rubber material originating from the squeegee on the optical device, is also avoided.

Another subject of the invention is a nozzle for spraying air, arranged to be fastened to a wiper blade with a view to forming a cleaning system as described above.

Another subject of the invention is a method for cleaning an optical surface of an optical device, this cleaning method comprising the following step:
spraying a jet of fluid in the direction of the optical surface using a nozzle for spraying fluid borne by a wiper blade for the window, this blade being arranged to wipe a wiping zone of the window that is separate from the optical surface.

According to one of the aspects of the invention, the method involves the following step:
controlling the spraying of the jet of fluid between a start-of-spraying angular position and an end-of-spraying angular position.

In other words, the jet of fluid, in particular air, is not ensured during the entire phase of operation of the wiper blade, but only during a limited time period in which the spray nozzle is closest to the optical surface to be cleaned.

For example, the optical surface to be cleaned is closest to the nozzle when the blade is in an angular position of A degrees with respect to a reference position, and the jet of air is triggered between a start-of-spraying angular position of (A−d) degrees and an end-of-spraying angular position of (A+d) degrees, the angle A being for example 75° or 80° and the angle d being for example of the order of 10° or 5°.

Thus, the jet of air is triggered intermittently.

According to one of the aspects of the invention, the angular position of the blade is detected by an angular position detector disposed at the electric motor of the blade. This detector is for example of the Hall effect type.

According to another of the aspects of the invention, the fluid is delivered to the nozzle in a continuous manner over the entire rising and falling travel of the blade.

### BRIEF DESCRIPTION OF DRAWINGS

Further features and advantages of the invention will become more clearly apparent upon reading the following description, which is given by way of illustrative and non-limiting examples, and the appended drawings, in which:

FIG. 1 schematically and partially illustrates a cleaning system according to one implementation example of the invention;

FIG. 2 schematically and partially illustrates the cleaning system in FIG. 1 during operation;

FIG. 3 schematically and partially illustrates, in cross section, the optical device of the system in FIG. 1, projecting from the window; and

FIG. 4 schematically and partially illustrates a cleaning system according to another implementation example of the invention.

### DETAILED DESCRIPTION OF THE INVENTION

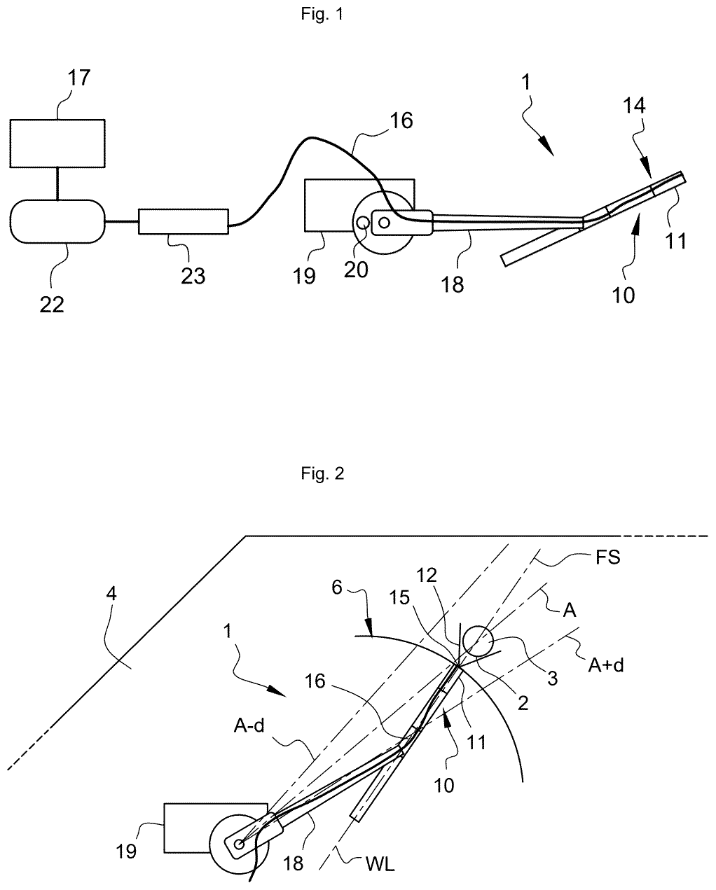

FIG. 1 and FIG. 2 show a system 1 for cleaning an optical surface 3 of an optical device 2, which optical device 2 is joined to a vehicle windshield 4.

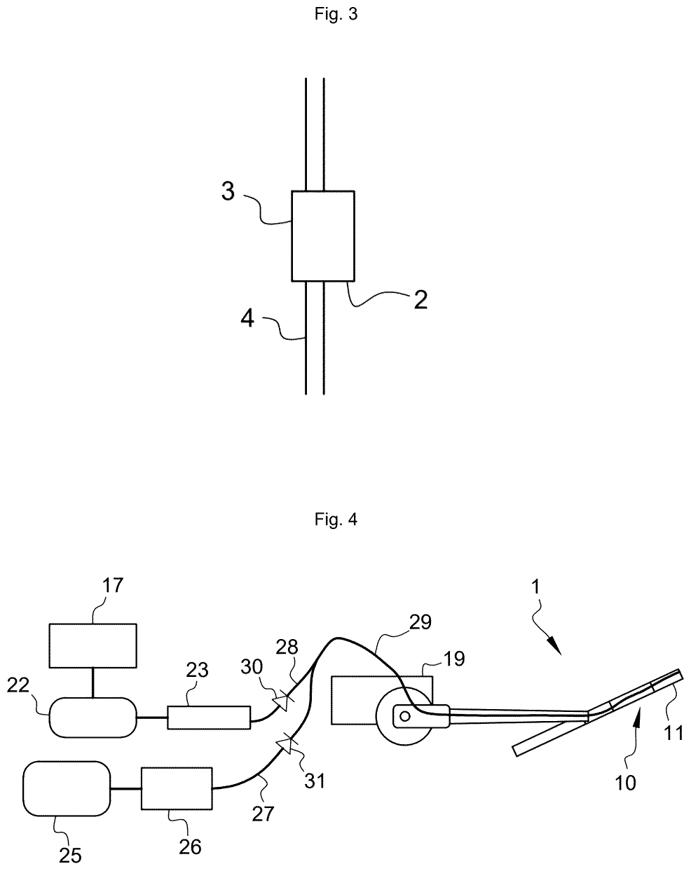

As can be seen in FIG. 3, the optical device 2 is joined to the windshield 4, projecting from this windshield 4.

The optical surface 3 is the surface through which the waves enter the optical device 2, which in the example described forms an infrared sensor.

The cleaning system 1 comprises a wiper blade 10 arranged to wipe a wiping zone 6 of the windshield 4 that is separate from the optical surface 3.

This blade 10 bears a nozzle 11 for spraying air in the direction of the optical surface 3.

The nozzle 11 thus delivers a jet of air 12 toward the optical surface 3.

This spray nozzle 11 is disposed at an end 14 of the wiper blade, from among its two opposite ends, which passes closest to the optical surface 3 during the sweeping.

The spray nozzle 11 comprises an air outlet orifice 15, with a convergent shape in order to accelerate the fluid.

This fluid outlet orifice 15 is configured so as to orient the sprayed fluid outside of the wiping zone 6.

In other words, the fluid that is sprayed by this spray nozzle 11 does not serve to clean the wiping zone 6.

The outlet 15 of the nozzle 11 has a fluid outlet axis FS that is tangent to a longitudinal axis WL of the wiper blade 10.

The spray nozzle 11 may comprise an internal fluid channel that opens onto the fluid outlet 15.

The spray nozzle 11 is formed by a part that is separate from the blade 10 and is joined to the blade 10, in particular by snap-fastening, screwing or welding.

The spray nozzle 11 may be fastened to the blade 10 in a removable manner, and is disposed in the longitudinal extension of the wiper blade 10.

The nozzle 11 is connected to a pipe 16 for conveying fluid toward the nozzle 11.

This pipe 16 connects an electric compressor 17 to the spray nozzle 11.

The wiper blade 10 is attached to a blade arm 18, and the pipe 16 that connects the compressor 17 to the spray nozzle 11 runs along the blade arm 18 over a certain length.

The compressor 17 is arranged to compress air, which is then conveyed toward the spray nozzle 11. This compressor 17 is placed on a fixed support separate from the wiper blade.

The blade arm 18 is connected to an electric motor 19 arranged to set it in wiping motion.

The electric motor 19 is coupled to an angular position sensor 20 arranged to determine the angle that the blade arm 18 makes with respect to a reference position,

In the example described, the cleaning system 1 also comprises a compressed air reservoir 22 supplied with compressed air from the compressor 17 that is placed upstream, and the spray nozzle 11 is supplied with compressed air coming from this compressed air reservoir 22.

By virtue of this reservoir 22, which serves as a buffer reservoir, the invention makes it possible to have compressed air immediately available, which may be conveyed very rapidly toward the spray nozzle 11.

The cleaning system 1 also comprises a solenoid valve 23 arranged to, in the open position, let compressed air circulate from the reservoir 22 toward the spray nozzle 11, and, in the closed position, stop the circulation of compressed air from the reservoir 22 toward the spray nozzle 11.

This valve 23 may be controlled with a very rapid reaction time, making it possible to deliver compressed air to the spray nozzle 11 in a very short time. This makes it possible in particular to have a pulsed air jet,

In the case of a pulsed air jet, it is possible to have a single opening/closure sequence of the valve 23 in the optical surface to be cleaned, or, as a variant, to have a plurality of opening/closure sequences of the valve 23 in the optical surface to be cleaned. This is made possible by the high reactivity of the solenoid valve allowing, for example, cycles of which the cycle time is less than 20 ms, and by the fact that the pulse has a very short lifetime.

If a blower is used, it is necessary to make provision for the nozzle to be activated sufficiently upstream of the optical surface to be cleaned since its startup time may take several seconds, and the blower remains switched on for the time required for the cleaning.

The nozzle 11 is made of plastic.

The optical device 2 is an infrared camera designed to participate in the autonomous driving assistance system of the vehicle.

The apparatus for setting the air in motion may be a blower, in place of the compressor 17. This blower is in particular a blower with radial blades.

According to one of the aspects of the invention, the optical device projects from the window

Cleaning using the system 1 is carried out in the following manner:
spraying the jet of air 12 in the direction of the optical surface 3 using the spray nozzle 11, controlling the spraying of the jet 12 between a start-of-spraying angular position (A−d) and an end-of-spraying angular position (A+d).

In other words, the jet of air 12 is not ensured during the entire phase of operation of the wiper blade, but only during a limited time period in which the spray nozzle 11 is closest to the optical surface 3 to be cleaned.

For example, the optical surface 3 to be cleaned is closest to the nozzle when the blade is in an angular position of A degrees with respect to a reference position, and the jet of air 12 is triggered between a start-of-spraying angular position of (A-d) degrees and an end-of-spraying angular position of (A+d) degrees, the angle A being for example 75° or 80° and the angle d being for example of the order of 10° or 5°.

The angular position of the blade 10 is detected by an angular position detector 20 disposed at the electric motor 19 of the blade. This detector 20 is for example of the Hall effect type.

In another implementation example of the invention, illustrated in FIG. 4, the spray nozzle 11 is connected to a reservoir of additional liquid 25, in this case a windshield washer liquid, so as to be able to be supplied, selectively, with this liquid alone, or with a mixture of this liquid and air, or with air alone.

The cleaning system comprises a pump 26 arranged to deliver liquid from the liquid reservoir 25 toward the spray nozzle 11.

A liquid path 27 coming from the liquid reservoir 26 and an air path 28 coming from the air reservoir 22 meet within a common pipe 29, upstream of the spray nozzle 11 such that this spray nozzle can be supplied selectively with air and/or liquid.

A non-return valve 30 is placed on the air path 28 in order to prevent liquid from being discharged into the air reservoir.

Another non-return valve 31 is placed on the liquid path 27 in order to prevent air from being discharged into the liquid reservoir 25.

In this embodiment, it is possible to distribute liquid alone, or a mixture of this liquid and air, or air alone, toward the nozzle 11, depending on the cleaning needs.

In an exemplary embodiment that is not illustrated, the spray nozzle is placed at a distance from the ends of the blade, for example at a location on the blade that is more than 5% or more than 10% of the total length of the blade away from the ends thereof.

What is claimed is:

1. A system for cleaning an optical surface of an optical device, this the cleaning system comprising:
a wiper blade for a window, the wiper blade being arranged to wipe a wiping zone of the window that is separate from the optical surface, the wiper blade bearing a nozzle for spraying fluid in the direction of the optical surface, and
an apparatus for setting fluid in motion intended to supply the spray nozzle.

2. The system as claimed in claim 1, wherein the spraying fluid is air alone, or a liquid alone, or a mixture of liquid and air.

3. The system as claimed in claim 1, wherein the spray nozzle is disposed at one end of the wiper blade which passes closest to the optical surface during the sweeping.

4. The system as claimed in claim 1, wherein the outlet of the nozzle has a fluid outlet axis that is tangent to the axis of the wiper blade.

5. The system as claimed in claim 1, wherein further comprising at least one pipe connecting the apparatus for setting fluid in motion to the spray nozzle.

6. The system as claimed in claim 1, wherein a blade arm is connected to an electric motor arranged to set it in wiping motion, and the electric motor is coupled to an angular position sensor arranged to determine the angle that the blade arm makes with respect to a reference position.

7. The system as claimed in claim 1, further comprising a compressed air reservoir supplied with compressed air from the apparatus for setting fluid in motion, and the spray nozzle is supplied with compressed air coming from the compressed air reservoir.

8. The system as claimed in claim 7, further comprising a valve arranged to, in the open position, let compressed air circulate from the compressed air reservoir toward the spray nozzle, and, in the closed position, stop the circulation of compressed air from the compressed air reservoir toward the spray nozzle.

9. A nozzle for spraying air, arranged to be fastened to a wiper blade with a view to forming a cleaning system, the cleaning system including the wiper blade for a window, the wiper blade being arranged to wipe a wiping zone of the window that is separate from the optical surface, the wiper blade bearing a nozzle for spraying fluid in the direction of the optical surface, and an apparatus for setting fluid in motion intended to supply the spray nozzle.

10. A method for cleaning an optical surface of an optical device, the cleaning method comprising:
spraying a jet of fluid in the direction of the optical surface using a nozzle for spraying fluid borne by a wiper blade for a window, the wiper blade being arranged to wipe a wiping zone of the window that is separate from the optical surface.
